(19) United States
(12) Patent Application Publication
(10) Pub. No.: US 2026/0257469 A1
(43) Pub. Date: Sep. 3, 2026

(54) APPLICATION SYSTEM, METHOD FOR PRODUCING A TRANSFER ROLLER AND APPLICATION PROCESS

(71) Applicant: LEONHARD KURZ Stiftung & Co. KG, Fürth (DE)

(72) Inventors: Ulrich SCHINDLER, Fürth (DE); Ralph HOPFENSITZ, Fürth (DE)

(21) Appl. No.: 19/489,996

(22) PCT Filed: Jun. 27, 2024
(86) PCT No.: PCT/EP2024/068111

§ 371 Date: Dec. 4, 2025

(30) Foreign Application Priority Data
Jun. 29, 2023 (DE) 10 2023 117 227.1

(51) Int. Cl. B41F 16/00

(52) U.S. Cl. CPC B41F 16/0026; B41P 2219/41

(57) ABSTRACT

A system for an indexed process of applying a transfer ply of a transfer film to a substrate, wherein the system is designed so as to avoid the generation of a potential difference greater than the breakdown voltage of the transfer film, of the roller outer surface of a transfer roller and/or of the surrounding gas phase as a result of friction between the roller outer surface of the transfer roller and transfer film rear side of the transfer film during the application process, to a method for producing the transfer roller, and to an application process.

The invention relates to an application system, to a method for producing a transfer roller, and to an application process.

It is known for transfer films to be arranged on at least parts of a substrate by means of application processes, by virtue of the substrate and transfer film being pressed against one another in the roller gap between two rollers. When using transfer films in application processes with film indexing, tree-shaped faults and/or blistering can occur on the surface of the decorated substrate or of the applied transfer ply.

These relevant faults can be explained by the fact that, when two different plastics surfaces which have different Fermi levels φ, such as a roller outer surface of a transfer roller and the transfer film rear side, come into contact and rub against one another, these two surfaces become charged. Thus, during the application step, an electrostatic charge is generated, which is induced by friction between the roller outer surface and the transfer film rear side. This electrostatic charge can be understood as a potential difference between the two surfaces.

Said rubbing leads to an electrostatic charge and to an electrical potential difference between the two surfaces after these have been separated from one another. Uncontrolled charging thus occurs, and the potential difference is measurable as an electrical voltage.

Here, the surface having the lower Fermi level φ constitutes the electron donor, and the surface having the higher Fermi level φ constitutes the electron acceptor. The roller outer surface and the transfer film rear side thus become charged after the steps of making contact, rubbing and moving apart. The potential difference increases over the course of the process. After a sufficiently high potential difference has been reached, an uncontrolled discharge ultimately occurs, which can lead to the above-described fault situation in the application process, in particular application step of the process. In particular in the case of transfer rollers having soft roller outer surfaces, the risk of a potential difference being induced is increased, because the effects contact area between the surfaces is larger.

There is thus a demand to avoid the above-described faults in an indexed application process.

It is an object of the invention to provide a system which makes possible an indexed application process with which the above-described fault situation is avoided. It is a further object of the invention to provide a method for producing an improved transfer roller, and an improved application process.

The object is achieved by means of a system for an indexed process of applying a transfer ply to a substrate, in particular by means of a system according to any one of claims 1 to 21, the system comprising a transfer roller and a counterpressure roller, and a transfer film, wherein the transfer roller has a roller outer surface, and the transfer roller and the counterpressure roller form a roller gap, wherein the transfer film has a carrier ply and has a transfer ply that is detachable from the carrier ply, and the transfer film rear side is formed by the carrier ply and the transfer film front side is formed by the transfer ply, wherein the transfer film rear side is in contact with the roller outer surface of the transfer roller and the transfer film front side is in contact with the substrate in the roller gap, wherein the transfer ply is applied to at least parts of the substrate, wherein the system is designed so as to avoid the generation of a potential difference greater than the breakdown voltage of the transfer film, of the roller outer surface of the transfer roller and/or of the surrounding gas phase as a result of the friction between the roller outer surface and transfer film rear side during the application process.

The object is also achieved by means of a method for producing a transfer roller having a roller outer surface according to any one of claims 1 to 21, preferably by means of a method for producing a transfer roller according to claims 22 to 43, the method having the following steps, in particular in the sequence a), b), c), d) or a), c), b), d):
a) providing a transfer roller,
b) arranging a rubber layer on the transfer roller,
c) arranging a functional layer on the rubber layer,
d) obtaining a transfer roller in the case of which the functional layer forms the roller outer surface of the transfer roller.

The object is also achieved by means of a process, in particular by means of a process according to any one of claims 44 to 47, for the indexed application of a transfer ply to a substrate, in particular by means of a system according to any one of claims 1 to 21, wherein a transfer roller, which has a roller outer surface, and a counterpressure roller form a roller gap, wherein the transfer film, which comprises a carrier ply and a transfer ply that is detachable from the carrier ply, is fed along the transfer roller into the roller gap, wherein the carrier ply forms the transfer film rear side and is in contact with the roller outer surface of the transfer roller, and wherein the transfer ply is brought into contact with the substrate in the roller gap, wherein the transfer ply is at least partially transferred to the substrate, wherein, during the process, the occurrence of a potential difference greater than the breakdown voltage of the transfer film, of the roller outer surface of the transfer roller and/or of the surrounding gas phase as a result of the friction between the roller outer surface of the transfer roller and the transfer film rear side is avoided.

It is also possible to provide a rubber layer or a rubber coating, in particular a printing blanket, which forms the roller outer surface, for use in the system according to any one of claims 1 to 21.

An indexed process is to be understood to mean a process in which individual process steps are carried out in direct succession, with the process being carried out inline. To carry out a process, it is possible for the various process steps to each be carried out in the same period of time. Depending on the particular process step, it may thus be necessary for the feed—for example of a transfer film—to be at least locally stopped. For example, in the application process, in particular in the process step of applying the transfer ply to the substrate, the feed of the transfer film in the roller gap may be locally stopped in order to thus optimally utilize the transfer film, ultimately in order to reduce costs and waste. This “transfer film stoppage” would be possible firstly by the movement of a dancer roller that is in contact with the transfer film (film store), and/or by virtue of an unwinding apparatus for the feed of the transfer film being stopped.

The subject matter of the present invention makes it possible for the potential differences that are generated between the roller surface and the carrier ply owing to the different Fermi levels φ during the indexed application process to be avoided or at least considerably reduced. This consequently means that no uncontrolled discharges occur during the process, and that the described fault situation does not arise during the application process.

This offers the advantage that the production of faulty surfaces and thus waste is reduced. In this way, the production process can be carried out in a more resource-conserving manner and with less financial outlay. Additionally, the avoidance or at least reduction of the potential difference also minimizes the risk of personnel being injured by electrocution (owing to charges) and/or of the system or the devices being damaged by power surges. Since power surges also constitute a potential ignition source, the risk of a machine fire in the presence of a flammable atmosphere is also reduced.

A further advantage associated with the reduction or minimization or avoidance of the potential difference is that the adhesion of dust or relatively small particles to the surfaces of the device or product is considerably reduced.

Further advantageous refinements of the invention are indicated in the dependent claims.

It is possible for the transfer roller to have a rubber layer comprising rubber, in particular soft rubber or hard rubber. The transfer roller may have a printing blanket, a covering or a coating, wherein, in particular, the rubber layer is formed from the printing blanket, the covering or the coating. The covering and/or the printing blanket may be of single-ply and/or multi-ply form. The coating may be of single-ply and/or multi-ply form.

The roller gap is in particular the gap between the roller outer surface of the transfer roller and the counterpressure roller. Preferably, on the transfer roller, a tensioning device is provided in which tensioning aids are each in particular frictionally and/or interlockingly held or fastened.

Preferably, a printing blanket or a covering is provided as rubber layer, wherein onto the functional layer on the printing blanket or the covering is obtained to obtain a printing blanket or a covering comprising the functional layer. The printing blanket or the covering is subsequently arranged on the roller.

As a rubber layer, it is also possible for a printing blanket or a covering to be provided, which are arranged on the transfer roller. It is also possible for a coating composition to be arranged on the transfer roller, with a coating being obtained. A transfer roller comprising the printing blanket, the covering or the coating is obtained. The functional layer is subsequently arranged on the printing blanket, the covering or the coating. In each of the above-described alternatives, a transfer roller is obtained in which the functional layer forms the roller outer surface.

The printing blanket, the covering or the coating preferably comprises rubber, in particular soft rubber or hard rubber. Preferably, the rubber layer, in particular the printing blanket, the covering or the coating, is compressible or incompressible, or is provided as such.

The printing blanket preferably has applied tensioning aids, in particular in the form of two metal strips. In particular, the printing blanket is fastened to the transfer roller by means of the tensioning aids, by means of a tensioning device situated on the transfer roller. In particular, use may be made of a printing blanket of an offset printing process or of an offset printing device.

The covering is preferably in the form of a sleeve or a hose. In particular, the covering is designed such that it can be pulled over the transfer roller, wherein the diameter of the covering is adapted to the diameter of the transfer roller such that said covering does not slip during the application process. It is possible for the diameter of the covering to be reduced by means of heat after said covering has been arranged on the transfer roller, with the covering thus being arranged on the transfer roller with an exact fit.

It is also possible for at least one coating composition to be provided, by means of which, after it has been arranged on the transfer roller, at least one coating is obtained. The coating composition preferably comprises one or more of the following constituents selected from the group consisting of reactive resins, in particular single-component systems, two-component systems, multi-component systems, polymer melts, polymer dispersions, polymer solutions or combinations thereof.

Preferably, a fabric is introduced into the coating after it has been or as it is being arranged and before it is cured and/or dried. More preferably, the coating is vulcanized, even more preferably cold-vulcanized, after it has been arranged.

It is possible for the coating to be provided by means of spray coating and/or by means of a corresponding adhesive bonding process and/or by means of a shrink-fitting process.

It is possible for the rubber layer, in particular the printing blanket, the covering or the coating, to be of multi-layer configuration and to have at least one fabric layer, or to be provided or applied as such. It is alternatively possible for the rubber layer, in particular the printing blanket, the covering or the coating, to be of single-layer configuration, or to be applied as such.

Preferably, the rubber layer, preferably a volume unit of the rubber layer, in particular of the printing blanket, of the covering or of the coating, comprises the constituents rubber, in particular soft rubber or hard rubber, fabric and gas. It is possible for the rubber layer, preferably the volume unit of the rubber layer, in particular of the printing blanket, of the covering or of the coating, to have the following composition, wherein the composition is selected so as to make up 100 vol. % in sum total:

### Rubber, in Particular Soft Rubber or Hard Rubber:

30 vol. % to 60 vol. %, more preferably 35 vol. % to 55 vol. %, even more preferably 40 vol. % to 50 vol. %,

### Fabric:

30 vol. % to 60 vol. %, more preferably 35 vol. % to 55 vol. %, even more preferably 40 vol. % to 50 vol. %,

### Gas:

0 vol. % to 25 vol. %, more preferably 1 vol. % to 15 vol. %, even more preferably 5 vol. % to 15 vol. %.

It is possible for the roller outer surface to be formed by a functional layer. The roller outer surface preferably has no rubber, in particular soft rubber or hard rubber. The roller outer surface is preferably to be understood to mean the roller outer surface of the transfer roller, which is more preferably formed by the functional layer.

It is possible for the roller outer surface, in particular functional layer, to be designed such that the charge generated by friction is dissipated. Preferably, the roller outer surface, in particular functional layer, is conductive or dissipative, or is configured as such.

Preferably, the roller outer surface, in particular the functional layer, has a sheet resistance R_{□} selected from a range from 0.001Ω/□ to 5000Ω/□, preferably from 0.01Ω/□ to 500Ω/□, more preferably from 0.1Ω/□ to 1 Ω/□.

In particular, the sheet resistance R_{□} may be measured or determined using the 2-point method (2PP) and/or the 4-point method (4PP) and/or the Hall effect method and/or the van der Pauw method, wherein all of these methods are electrical testing methods which can be used for testing, by contact, the electrical parameter of layer resistance, in particular sheet resistance R_{□} of the functional layer.

By contrast, if it is intended to measure the sheet resistance R_{□} contactlessly, it may be preferable to choose the eddy current method, in which so-called eddy currents are induced in the conductive materials, which then give rise to a secondary field opposed to the primary field, from which it is then possible to determine the layer resistance, in particular the sheet resistance R_{□} of the functional layer.

The sheet resistance R_{□} describes the electrical resistance measured on the surface of a layer and is stated in the units of Ω/□ (ohms per unit area, or ohms per square). It thus differs fundamentally from the volume resistivity of a body. It is possible to understand the sheet resistance R_{□} as a layer resistance, in particular of a resistance layer. In particular, the layer resistance of the functional layer is understood as the sheet resistance R_{□}.

It is to be emphasized in this context that numerous industrial sectors use their own measurement standards for determining the layer resistance using the eddy current.

These include ASTM F1844-97 (2016) (publication date: 2016 May), a standard method for measuring the layer resistance of thin film conductors in the flat panel display manufacturing sector. It is possible for the sheet resistance to be determined using a method described in in ASTM F1844-97 (2016).

The term “conductive” applies if the layer has a sheet resistance R_{□} of less than 1×10⁶Ω/□. The term “dissipative” applies if the layer has a sheet resistance R_{□} selected from the range from 1×10⁶Ω/□ to 1×10⁹Ω/□. The roller outer surface is understood to be “non-conductive” if it has a sheet resistance R_{□} of more than 1×10⁹Ω/□.

It is possible for the roller outer surface, in particular the functional layer, to have conductive or dissipative constituents. In particular, the functional layer comprises metals, in particular selected from the group consisting of iron, nickel, titanium, chromium, molybdenum, manganese, tantalum, copper, gold, silver, aluminum or mixtures and alloys thereof. In a preferred embodiment, the functional layer has aluminum. It is possible for the functional layer to have a metal alloy selected from the group consisting of iron-nickel, copper-nickel, nickel-copper, nickel-chromium or mixtures thereof.

Preferably, the roller outer surface, in particular the functional layer, consists entirely of metal, in particular selected from the above group, or has a binder, in particular a polymer. The binder may be conductive, dissipative or non-conductive.

The roller outer surface, in particular the functional layer, preferably has conductive or dissipative carbon modifications, in particular selected from the group consisting of graphene, fullerenes, carbon nanotubes, graphite, carbon black or combinations thereof. It is possible for the roller outer surface, in particular the functional layer, to have conductive or dissipative polymers. It is possible for the roller outer surface, in particular the functional layer, to have a combination of metal, conductive or dissipative carbon modifications and/or conductive or dissipative polymers.

It is possible for the Fermi levels φ of the roller outer surface, in particular of the functional layer, and of the carrier ply to be aligned with one another. Expediently, the difference between the Fermi levels φ of the roller outer surface, in particular of the functional layer, and of the carrier ply is reduced. A mutual alignment may be achieved for example by selectively choosing the constituents of the roller outer surface, in particular of the functional layer, and of the carrier ply. In particular, the Fermi levels φ of the roller outer surface of the transfer roller, in particular of the functional layer, and of the carrier ply are substantially equal, in particular in a cleaned state and/or in a standard atmosphere. In particular, in this case, the roller outer surface, in particular the functional layer, is non-conductive, or is configured as such.

In particular, it is possible for the constituents of the roller outer surface, in particular of the functional layer, and of the carrier ply to be selected such that the work functions of the roller outer surface, in particular of the functional layer, and of the carrier ply differ by at most 30%, preferably at most 20%, more preferably at most 15%. The work function is the minimum amount of energy that must be expended to release an electron from an uncharged solid, in particular the functional layer and/or the carrier ply.

A standard atmosphere is to be understood, in accordance with DIN EN ISO 139:2011-10 (“Textiles-Standard atmospheres for conditioning and testing (ISO 139:2005+Amd.1:2011); German version EN ISO 139:2005+A1:2011”, publication date: 2011 October), to mean a temperature of 20° C. and a relative air humidity of 50% at an air pressure of 1013 mbar.

The constituents of the roller outer surface, in particular of the functional layer, and the carrier ply are preferably selected such that these lie close together with reference to the triboelectric series. In particular, the spacing, in the triboelectric series, of the roller outer surface and the carrier ply is less than the spacing of the roller outer surface and of the carrier ply to air or rubber layer. The triboelectric series indicates the electron affinity of a material of a surface. The closer the material is to the positive end of the series, the more electrons are released when the surface is rubbed against the surface of a second material that is situated closer to the negative end of the series.

Preferably, the roller outer surface, in particular the functional layer, is formed from the same polymer as the carrier ply.

It is possible for the polymer of the roller outer surface, in particular of the functional layer, and of the carrier ply to be selected from the group consisting of PFP, polyethylene (PE), polycarbonate (PC), polypropylene (PP), polyvinyl chloride (PVC), polystyrene (PS), polyether imide (PEI), polybutylene terephthalate (PBT), polyethylene terephthalate (PET), acrylonitrile butadiene styrene copolymer (ABS), cellophane, polylactide (PLA), cellulose diacetate, cellulose triacetate (CTA), biaxially oriented polyethylene terephthalate (BO-PET), starch blends, polymethyl methacrylate (PMMA), or copolymers and/or blends and/or multilayer composites thereof. Preferably, the polymer of the roller outer surface, in particular of the functional layer, is composed of polyethylene terephthalate, preferably of biaxially oriented polyethylene terephthalate.

PFP is to be understood to mean a paper-film-paper composite, which in particular has a plastics film as a middle ply and has two outer paper plies connected to the middle ply. PFP may in particular be produced, by lamination, from a plurality of prefabricated material plies, which may be interconnected in particular by means of adhesive. Owing to the outer paper surface, PFP can be easily printed and written upon, and is nevertheless more tear-resistant than an individual paper layer.

BO-PET is to be understood to mean biaxially oriented polyethylene terephthalate, in particular a biaxially oriented polyethylene terephthalate film.

In a preferred embodiment, the roller outer surface, in particular the functional layer, and the carrier ply, in particular the transfer film rear side, consist substantially of polyethylene terephthalate, preferably of biaxially oriented polyethylene terephthalate. In a further preferred embodiment, the roller outer surface, in particular the functional layer, and the carrier ply, in particular the transfer film rear side, consist substantially of polycarbonate.

It is possible for the roller outer surface, in particular the functional layer, to be formed from constituents which have a dielectric strength selected from a range from 5 kV/mm to 800 kV/mm, preferably from 100 kV/mm to 350 kV/mm, more preferably from 150 kV/mm to 300 kV/mm, in particular measured in a standard atmosphere and preferably in the case of cleaned surfaces. In particular, the dielectric strength is determined in accordance with a method described in in DIN EN 60243-2 VDE 0303-22:2014-08 (“Electric strength of insulating materials—Test methods”, publication date: 2014 August)”.

The following table 1 specifies typical plastics materials and their dielectric strength at a temperature of 23° C.

TABLE 1
Dielectric strength E_{d} of films composed of typical
plastics materials at a temperature of 23° C.

| Plastics films | Thickness d (μm) | E_{d} (kV mm⁻¹) |
|---|---|---|
| Polypropylene (PP) | 40 | 200 |
| Polyester | 40 | 160 |
| Polyvinyl chloride (PVC) | 40 | 150 |
| Cellulose acetate butyrate | 40 | 130 |
| Cellulose triacetate | 40 | 120 |
| PE | 140 | 110 |
| PE | 1000 | 40 |
| PET, partially crystalline | — | 30 |
| PET, amorphous | — | 250 |
| Polycaprolactam (PA 6) | 1000 | 15 |
| PBT | 1600 | 13 |
| Polyvinylidene fluoride | 1000 | 40 |
| (PVDF) | | |
| Polyether ether ketone | 1600 | 25 |
| (PEEK) | | |
| PS | 1600 | 43 |
| ABS | 1000 | 41 |
| Styrene acrylonitrile | 1600 | 32 |
| copolymer (SAN) | | |
| Polysulfone (PSU) | 1000 | 30 |
| Polyethersulfone (PES) | 1000 | 35 |
| Polyethylenimine (PEI) | 800 | 33 |
| Polyvinyl chloride, | 600 | 40 |
| unplasticized (PVC-U) | | |

Dielectric strength is to be understood to mean the maximum electric field strength that can prevail in a non-conductive body of a defined thickness without a dielectric breakdown occurring, or is the electric field strength at which the conductivity of an insulator increases by several orders of magnitude.

The potential difference at which the dielectric breakdown occurs is referred to as the breakdown voltage. According to the invention, the potential difference between the transfer film, the roller outer surface and/or the surrounding gas phase must lie below the breakdown voltage.

The value of the dielectric strength is dependent on various factors, in particular on the thickness of the carrier ply, surface condition of the carrier ply, coating of the carrier ply, composition of the carrier ply, state of charge of the carrier, humidity, temperature, pressure and composition of the gas phase surrounding the system, water absorbency of the carrier ply, compressibility of the layer that forms the roller outer surface and/or of the carrier ply, and the adhesive properties of the adhesive on the substrate, said adhesive being necessary for the transfer of the carrier film layers, in particular of the transfer ply, and inevitably also having an influence, owing to evaporated solvents or substances, on the gas phase surrounding the system.

Preferably, the functional layer is in contact with the rubber layer, in particular with the printing blanket, the covering or the coating, or is arranged as such.

It is possible for the functional layer to be of single-layer or multi-layer configuration or form. The functional layer is preferably arranged on the rubber layer over the full area thereof.

It is possible for the functional layer to be deposited from the vapor phase, in particular with a layer thickness selected from the range from 5 nm to 500 nm, preferably from 10 nm to 200 nm, more preferably from 30 nm to 55 nm. In particular, conductive polymers or the aforementioned metals or metal alloys are deposited. In particular, a conductive or dissipative roller outer surface, in particular functional layer, is obtained.

It is possible for the functional layer to be deposited from a salt solution, in particular with a layer thickness selected from the range from 5 nm to 600 nm, preferably from 20 nm to 300 nm, more preferably from 70 nm to 150 nm. In particular, a conductive or dissipative roller outer surface, in particular functional layer, composed of the aforementioned metals, in particular silver, is obtained here.

Here, an aqueous salt solution is preferably present, with a reducing agent being added to the salt solution. The salt solution preferably comprises salts selected from the group consisting of AgNO₃, NiSO₄, CuSO₄, K[Au(CN)₂], Na₃[Au(SO₃)₂], SnCl₂ or of combinations thereof.

Examples for metallization electrolytes (Source: “Verfahren der Oberflächentechnik” [“Surface engineering methods”], 1st edition 2004, ISBN 9783446222281) include the following:

### Ag Deposition:

0.6 g silver nitrate
   50 ml distilled H₂O
   0.8 g NaOH and 50 ml distilled H₂O and a few drops of 25% NH₄OH

### Ni Deposition:

NISO₄·7H₂O 20 g/l to 30 g/l
   NaH₂PO₂·H₂O 10 g/l to 20 g/l
   Acetic acid 10 g/l with NaOH to pH 4.5
   Thiourea 0.7 mg/l
NiSO₄·7H₂O 20 g/l
   NaH₂PO₂·H₂O 15 g/l
   Lactic acid 30 g/l
   Propionic acid 3 g/l
   Pb(NO₃)₂ 1 mg/l with Na-acetate to pH 4 to 5
NiSO₄·7H₂O 20 g/l
   NaH₂PO₂·H₂O 15 g/l
   Citric acid 15 g/l
   Na₂B₄O₇·10 H₂O 15 g/l with NaOH to pH 9.5

### Cu Deposition:

CuSO₄·5H₂O 10 g/l
   Methanal (formalin solution 30%) 20 ml/l
   EDTA 16 g/l
   NaOH 10 g/l
CuSO₄·5H₂O 5 to 10 g/l
   Methanal (formalin solution 30%) 35 ml/l
   Potassium sodium tartrate KNaC₄H₄O₄·4H₂O 5 to 10 g/l
   Thiourea 0.05 mg/l
   NaOH 4 g/l to 5 g/l

### Au Deposition:

K[Au(CN)₂] 5 g/l to 15 g/l
   KBH₄ 12 g/l to 17 g/l
   KCN 10 g/l to 15 g/l
   KOH 10 g/l to 13 g/l
K[Au(CN)₂] 5 g/l
   COCl₂·6H₂O 20 g/l
   NiCl₂·6H₂O 10 g/l
   Thiourea 25 g/l
   Di-ammonium hydrogen citrate 20 g/l
Na₃[Au(SO₃)₂] 0.6 g/l
   Methanal (formalin solution 30%) 20 ml/l 0.3 g/l to 0.5 g/l
   Na₂SO₃ 5 g/l
   Ethylenediamine (50%) 0.85 g/l
   Sodium citrate dihydrate 8 g/l
   NH₄Cl 15 g/l

### Sn Deposition:

SnCl₂·2H₂O 7.5 g/l
   Na₂HPO₂·7H₂O 2 g/l
   EDTA 15 g/l
   Sodium acetate 10 g/l
   Benzenesulfonic acid 1 ml/l
SnCl₂·2 H₂O 5 g/l
   Thiourea 50 g/l
   H₂SO₄ 20 g/l

It is possible for the functional layer to be obtained using at least one of the above salt mixtures.

It is possible for the functional layer to be applied or present as a lacquer layer. Preferably, the lacquer layer is applied with a layer thickness selected from the range from 2 μm to 100 μm, preferably from 10 μm to 25 μm. The functional layer is preferably applied as a print lacquer, spray lacquer, reaction lacquer or as a combination thereof.

It is possible for the functional layer, in particular lacquer layer, to be printed on, in particular by means of a printing process and/or spraying process selected from the group consisting of relief printing, planographic printing, screen printing, gravure printing, inkjet printing or combinations thereof.

It is possible for the functional layer to be produced from a conductive lacquer and to be provided as a conductive or dissipative lacquer layer. The conductive lacquer is in particular a silver conductive lacquer or conductive silver, a copper conductive lacquer, and/or a graphite conductive lacquer.

In particular, the conductive lacquer or the conductive or dissipative lacquer layer comprises one or more of the following particles, in particular nanoparticles: silver, copper, conductive carbon modifications, in particular graphene, carbon nanotubes or graphite, carbon black, gold, aluminum and/or metal alloys. In particular, a conductive or dissipative roller outer surface, in particular functional layer, is obtained. The conductive lacquer preferably comprises a lacquer, a polymer dispersion, a polymer solution, or a synthetic resin, as a binder. Synthetic resins are preferably also suitable as a conductive adhesive, that is to say in particular for forming an adhesive layer in the functional layer. The lacquer layer, in particular conductive or dissipative lacquer layer, preferably comprises a polymer as a binder.

As an alternative to the conductive lacquer, in order to preferably targetedly dissipate charges owing to the indexing, it is possible for a non-conductive lacquer layer to be provided. The non-conductive lacquer layer preferably comprises a polymer dispersion, a polymer solution, or a synthetic resin, as a binder. The non-conductive lacquer layer preferably comprises a non-conductive polymer as a binder. In other words, the lacquer layer does not have any conductive or dissipative constituents.

The non-conductive lacquer layer or the binder thereof is preferably formed from the same polymer as the carrier ply. It is possible for the polymer of the non-conductive lacquer layer and of the carrier ply to be selected from the group consisting of PFP, polyethylene, polycarbonate, polypropylene, polyvinyl chloride, polystyrene, polybutylene terephthalate, polyethylene terephthalate, acrylonitrile butadiene styrene copolymer, cellophane, polylactide, cellulose diacetate, cellulose triacetate, BO-PET, starch blends, polymethyl methacrylate, or copolymers and/or blends thereof. The polymer of the non-conductive lacquer layer and of the carrier ply is preferably polyethylene terephthalate.

The lacquer layer, in particular the conductive or dissipative lacquer layer or the non-conductive lacquer layer, preferably comprises a solvent-based or water-based binder. The binder may be of single-component or two-component or multi-component form.

The lacquer layer, in particular the conductive or dissipative lacquer layer or the non-conductive lacquer layer, is preferably of single-layer or multi-layer configuration. It is possible for the functional layer, preferably the lacquer layer, more preferably the conductive or dissipative lacquer layer or the non-conductive lacquer layer, to comprise a plurality of layers which are of different composition. It is also possible for the lacquer layer, in particular the conductive or dissipative lacquer layer or the non-conductive lacquer layer, to be formed in a layer composite. For example, the lacquer layer, in particular the conductive or dissipative lacquer layer, may be present in conjunction with one or a plurality of vapor-deposited metal layers or transparent oxide layers.

In one embodiment, it is possible for the functional layer to be provided as a film. The film is preferably laminated or stamped onto the printing blanket, the covering or the coating. Preferably, the film is a metal film, or is provided as such. This film, in particular the metal film, preferably has a layer thickness in the range from 2 μm to 200 μm, preferably from 5 μm to 100 μm, more preferably from 20 μm to 40 μm, wherein, in particular, the layer thicknesses are layer thicknesses of the pure metal film without additionally applied layers. An adhesive layer, in particular for arranging the metal film on the roller outer surface, preferably has a layer thickness in the range from 5 μm to 250 μm, preferably from 10 μm to 100 μm, more preferably from 20 μm to 50 μm.

More preferably, the film is a polymer film, or is provided as such. This film, in particular the polymer film, preferably has a layer thickness selected from the range from 4 μm to 500 μm, preferably from 6 μm to 50 μm, more preferably from 6 μm to 12 μm, wherein the layer thicknesses are layer thicknesses of the pure polymer film without additionally applied layers. An adhesive layer, in particular for arranging the polymer film on the roller outer surface, preferably has a layer thickness in the range from 5 μm to 250 μm, preferably from 10 μm to 100 μm, more preferably from 20 μm to 50 μm.

If the film is provided as a polymer film, a non-conductive roller outer surface is preferably obtained. Preferably, the polymer film is formed from the same polymer as the carrier ply, wherein the polymer is preferably selected from the group consisting of PFP, polyethylene, polycarbonate, polypropylene, polyvinyl chloride, polystyrene, polybutylene terephthalate, polyethylene terephthalate, acrylonitrile butadiene styrene copolymer, cellophane, polylactide, cellulose diacetate, cellulose triacetate, BO-PET, starch blends, polymethyl methacrylate, or copolymers and/or blends thereof. The polymer film is preferably composed of polyethylene terephthalate, preferably of biaxially oriented polyethylene terephthalate.

If the functional layer is provided as a metal film, a conductive or dissipative roller outer surface is obtained, which in particular is composed of the metals or metal alloys described above.

As a film, it is also possible for a polymer film to be provided which has a metal layer, wherein the metal layer is arranged on that side of the film which faces away from the roller. The metal layer, in particular composed of the metals or metal alloys described above, thus forms the roller outer surface, with a conductive or dissipative roller outer surface being obtained.

Preferably, the polymer film has a layer thickness in the range from 4 μm to 500 μm, preferably from 6 μm to 50 μm, more preferably from 6 μm to 12 μm.

It is possible for the metal layer to be deposited from the vapor phase, in particular with a layer thickness in the range from 5 nm to 500 nm, preferably from 10 nm to 200 nm, more preferably from 30 nm to 55 nm. In particular, in this case, metals or metal alloys are deposited which are in particular selected from the group consisting of iron, nickel, titanium, chromium, molybdenum, manganese, tantalum, copper, gold, silver, aluminum or mixtures and alloys thereof.

It is possible for an adhesive layer to be arranged between the film, in particular the polymer film or the metal film, and the rubber layer, in particular the printing blanket, the covering or the coating. It is alternatively or additionally possible for the film, in particular the polymer film or the metal film, to be provided with an adhesive layer, wherein the adhesive layer is arranged on that side of the film which faces toward the roller. Preferably, the adhesive layer is arranged with, or has, a layer thickness selected from the range from 5 μm to 250 μm, preferably from 10 μm to 100 μm, more preferably from 20 μm to 50 μm.

It is possible that, if a printing blanket is used as rubber layer, and the functional layer is provided as a film, in particular polymer film and/or metal film, the film is clamped onto the printing blanket by means of tensioning aids, in particular in the form of two metal strips. For this purpose, in particular, the printing blanket and the film are interconnected by means of two tensioning aids, preferably by means of two metal strips, wherein, in particular, the printing blanket is then fastened or stretched onto the transfer roller by means of the two tensioning aids and by means of a tensioning device situated on the transfer roller. A printing blanket is thus obtained which comprises the film, in particular polymer film and/or metal film.

Alternatively, the functional layer may be provided as a hose, sleeve or covering, wherein this may be configured in the manner of the film, in particular polymer film and/or metal film, described above. In other words, the film may be configured as a hose, sleeve or covering. Preferably, the film has a layer thickness in the range from 4 μm to 500 μm, preferably from 6 μm to 50 μm, more preferably from 6 μm to 12 μm, and is preferably a polymer film.

It is possible for the carrier ply to consist of a constituent selected from the group consisting of PFP, polyethylene, polypropylene, polyvinyl chloride, polycarbonate, polystyrene, polyethylene terephthalate, acrylonitrile butadiene styrene copolymer, cellophane, polybutylene terephthalate, polymethyl methacrylate, or copolymers, polylactide, cellulose diacetate, cellulose triacetate, BO-PET, starch blends, and/or blends thereof. The carrier ply is preferably composed of polyethylene terephthalate, more preferably of biaxially oriented polyethylene terephthalate, and is in particular non-conductive.

It is also possible for the carrier ply to be a co-extruded product, a tri-extruded product or a multi-extruded product from the above group. The carrier ply may also be filled or coated. It is possible for the carrier ply to be a multilayer composite and/or a fabric carrier. A biopolymer-based carrier ply is also possible.

It is possible for the carrier ply to have, or be provided with, a layer thickness selected from the range from 4 μm to 5000 μm, preferably from 6 μm to 250 μm, more preferably from 9 μm to 23 μm.

It is possible for the carrier ply to have, or be provided with, surface properties selected from the group consisting of smooth, rough, fully or partially structured and/or microstructured, perforated, fully or partially coated, or combinations thereof. It is also possible for the carrier ply to be colored and/or transparent or opaque. The transfer film or the substrate may be provided in the form of roll material or in the form of sheet material.

The system according to the invention may preferably be arranged in a device, preferably cold stamping device and/or hot stamping device. The process carried out by means of the system and/or the device, or the application process according to the invention, is preferably a cold stamping process and/or a hot stamping process.

The device and/or the system preferably has at least one or more apparatus(es) for accommodating rolls of film, in particular of the transfer film and/or of the carrier ply and/or of the substrate. The device and/or the system preferably has an unwinding apparatus by means of which the provided transfer film can be fed to the process and which, in the advancing direction, is arranged upstream of the roller gap. The device and/or the system preferably has a winding apparatus by means of which the carrier ply can be discharged from the process and which, in the advancing direction, is arranged downstream of the roller gap. The device preferably has a tensioning device for fastening the tensioning aid above the transfer roller.

The device preferably has one or more printing apparatuses, in particular apparatuses for relief printing, planographic printing, screen printing, gravure printing, inkjet printing or combinations thereof, which, in the advancing direction, is arranged upstream of the system, in particular upstream of the roller gap. Preferably, in particular by means of at least one of the printing apparatuses, an adhesive layer, in particular a cold stamping adhesive layer or a hot stamping adhesive layer, is applied to the substrate. The adhesive layer is preferably a UV-curable adhesive layer. It may be advantageous if the device has a curing apparatus, in particular comprising a UV source, for curing the adhesive layer. This is advantageous if the device and/or the system is arranged in a cold stamping process or is a cold stamping apparatus.

It is possible for the transfer roller and/or the counterpressure roller to be heatable, in particular if a hot stamping adhesive layer is present or arranged on the substrate or the transfer ply. The adhesive layer is preferably a hot-melt adhesive layer. This is advantageous if the device and/or the system is arranged in a hot stamping process or is a hot stamping apparatus.

In particular, the system and/or the device has at least one control apparatus for controlling the feed of the transfer film and/or of the substrate to the roller gap. In particular, the feed of the transfer film in the roller gap is stopped by virtue of the unwinding apparatus and/or winding apparatus for the transfer film being stopped, by virtue of the film tension of the transfer film being adjusted, and/or by virtue of a dancer roller that is in contact with the transfer film being moved.

It is possible for the absolute value of the maximum rotational speed of the transfer roller at a point arranged on the roller outer surface to lie in the range from 500 revolutions/h to 30000 revolutions/h, preferably from 5000 revolutions/h to 24000 revolutions/h, more preferably from 15000 revolutions/h to 18000 revolutions/h, in particular in relation to the central point of the roller.

It is self-evidently also possible for product features mentioned above to be used equivalently in a method, or for method features that have been mentioned to be used in a product.

The invention will be discussed by way of example below on the basis of a plurality of exemplary embodiments and with reference to the appended drawings. The exemplary embodiments shown are therefore not to be understood as limiting.

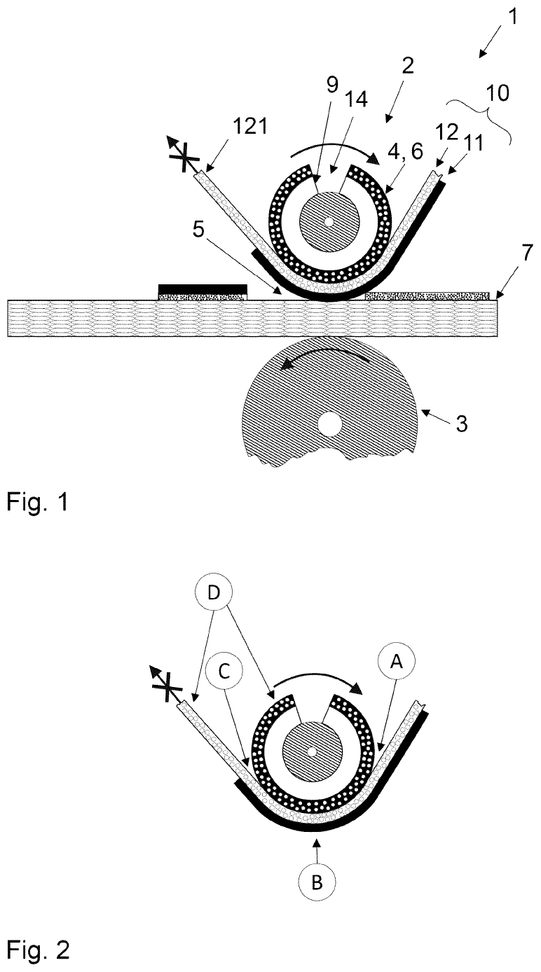

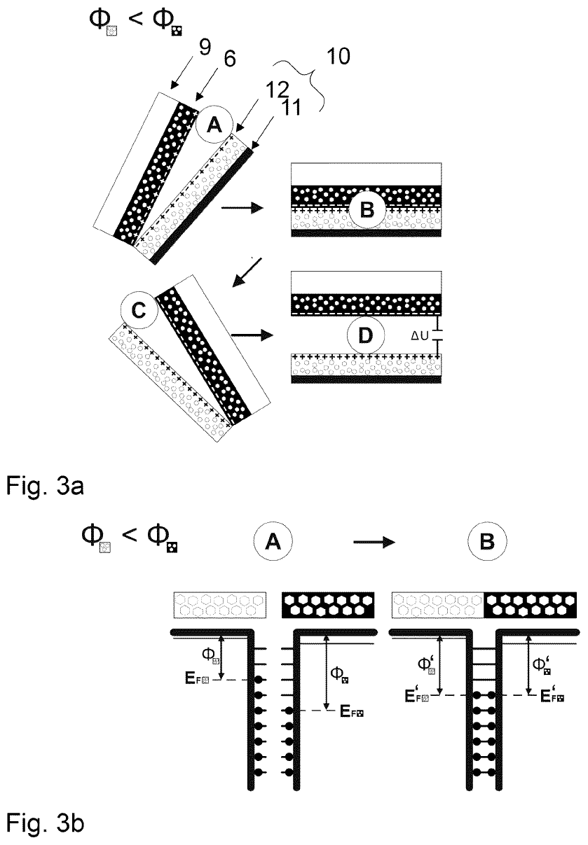

FIGS. 1 and 2 are schematic illustrations of a system.

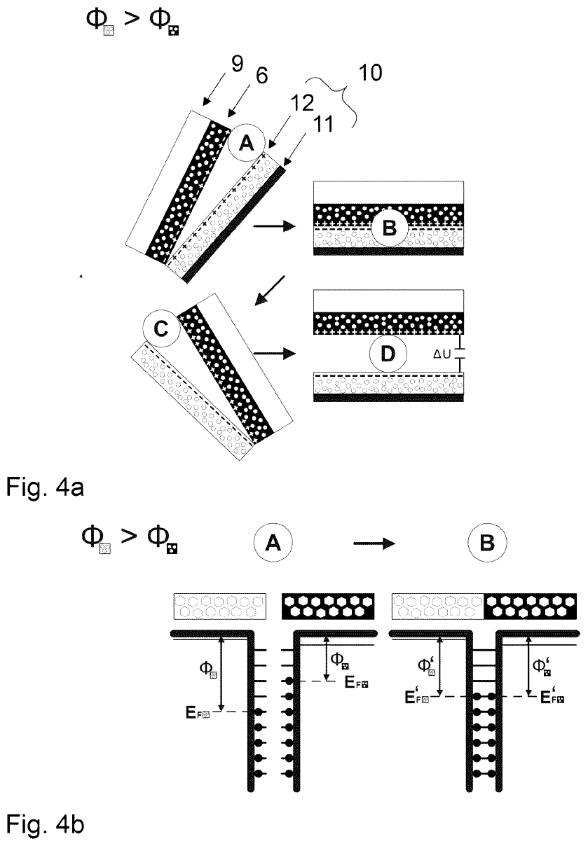

FIGS. 3a, b and 4a, b are schematic illustrations of an application process in which a potential difference is induced.

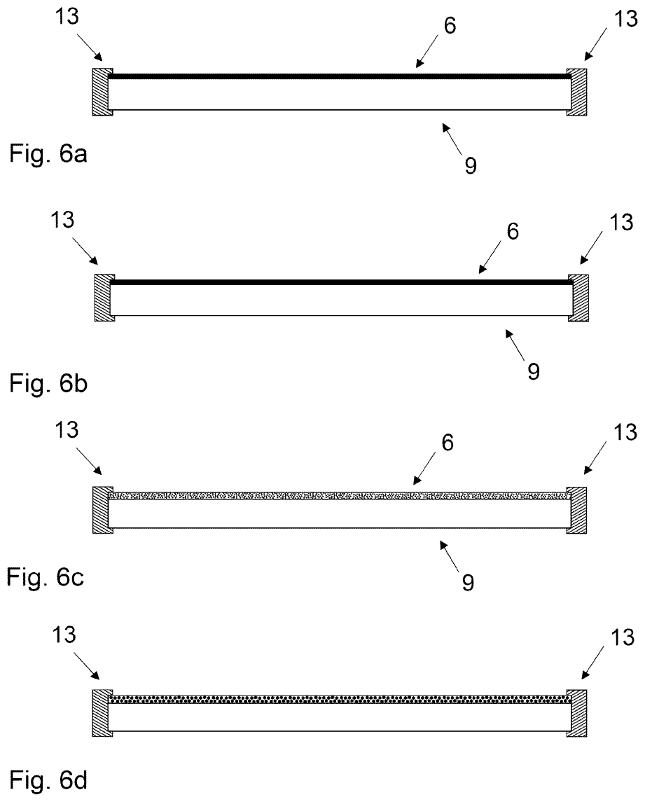

FIG. 5a, b are schematic illustrations of an application process in which no potential difference is induced.

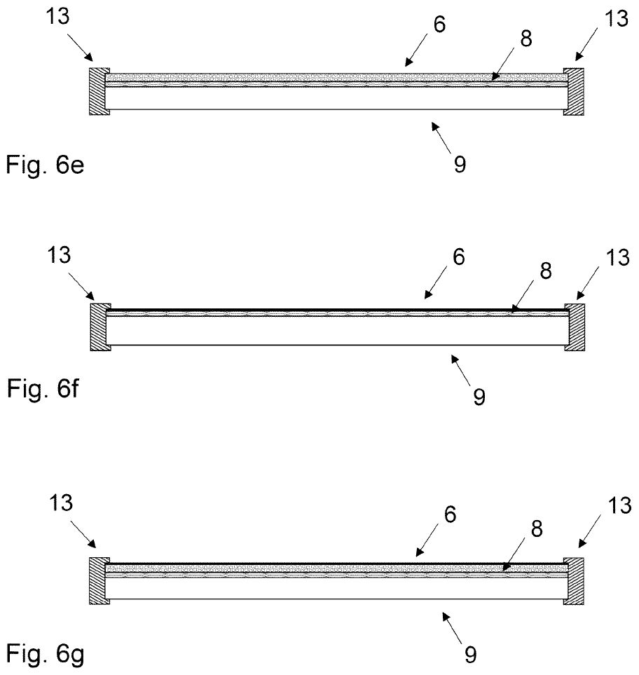

FIGS. 6a to 6f are schematic illustrations of roller outer surfaces.

FIG. 1 shows a system 1 according to the invention for an indexed process of applying a transfer ply 11 to a substrate 7. In particular, the system 1 shown in FIG. 1 can be used to carry out the process according to the invention for the indexed application of a transfer ply 11 to the substrate 7. The system 1 comprises a transfer roller 2, which has a roller outer surface 4, and a counterpressure roller 3. The transfer roller 2 and counterpressure roller 3 together form a roller gap 5. The system 1 furthermore has a transfer film 10, wherein the transfer film 10 comprises a carrier ply 12 and a transfer ply 11 that is detachable from the carrier ply 12. The transfer film rear side 121 is formed by the carrier ply 12, and the transfer film front side is formed by the transfer ply 11. The transfer film rear side 121 is in contact with the roller outer surface 4, and the transfer film front side is in contact with a substrate 7 in the roller gap 5—gap between the roller outer surface 4 of the transfer roller 2 and the counterpressure roller 3. In the roller gap, the transfer ply 11 is applied to at least parts of the substrate 7.

The system 1 according to the invention is designed such that no potential difference, in particular no electrical voltage resulting from the potential difference, which exceeds the breakdown voltage of the transfer film 10, of the roller outer surface 4 and/or of the surrounding gas phase is generated as a result of the friction, in particular electrostatic charge induced by the friction, between the roller outer surface 4 of the transfer roller 2 and the transfer film rear side 121 during the indexing step between the application steps, in particular the application steps of the process.

FIG. 1 schematically illustrates the process phase in which the feed of the transfer film 10 into the roller gap 5—gap between the roller outer surface 4 of the transfer roller 2 and the counterpressure roller 3—has been stopped. This is possible for example in the indexing process step between the application of the transfer ply 11 to the substrate 7. This is possible by the movement of a dancer roller that is in contact with the transfer film 10, by the adjustment of the film tension and/or by virtue of an unwinding apparatus for the feed of the transfer film 10 being stopped.

It is possible for the transfer roller 2 to have a rubber layer 9 comprising rubber, in particular soft rubber or hard rubber. The transfer roller 2 may have a printing blanket, a covering or a coating, wherein, in particular, the rubber layer 9 is formed from the printing blanket, the covering or the coating. The covering and/or the printing blanket may be of single-ply and/or multi-ply form. The coating may be of single-ply and/or multi-ply form. Provided on the transfer roller 2 is a tensioning device 14 in which tensioning aids 13 are each in particular frictionally and/or interlockingly held or fastened.

The transfer roller 2 according to the invention having a roller outer surface is produced in accordance with a method according to the invention, wherein the method has the following steps, in particular in the sequence a), b), c), d) or a), c), b), d):
a) providing a transfer roller 2,
b) arranging a rubber layer 9 on the transfer roller 2,
c) arranging a functional layer 6 on the rubber layer 9,
d) obtaining a transfer roller 2 in the case of which the functional layer 6 forms the roller outer surface 4.

Preferably, the printing blanket or the covering is provided as rubber layer 9, wherein onto the functional layer 6 on the printing blanket or the covering is obtained to obtain the printing blanket or the covering comprising the functional layer 6. The printing blanket or the covering is subsequently arranged on the roller. The printing blanket preferably has tensioning aids 13, in particular in the form of two metal strips. In particular, the printing blanket is fastened to the transfer roller 2 by means of the tensioning aids 13 and by means of a tensioning device 14 (not shown in detail here) situated on the transfer roller. The tensioning aids 13 are each in particular frictionally and/or interlockingly held or fastened in the tensioning device 14.

The covering is preferably in the form of a sleeve or a hose. In particular, the covering is designed such that it can be pulled over the transfer roller 2, wherein the diameter of the covering is adapted to the diameter of the transfer roller 2 such that said covering does not slip during the application process. It is possible for the diameter of the covering to be reduced by means of heat after said covering has been arranged on the transfer roller, with the covering thus being arranged on the transfer roller with an exact fit.

It is also possible for at least one coating composition to be provided, by means of which, after it has been arranged on the transfer roller 2, at least one coating is obtained. The coating composition preferably comprises one or more of the following constituents selected from the group consisting of reactive resins, in particular single-component systems, two-component systems, multi-component systems, polymer melts, polymer dispersions, polymer solutions or combinations thereof. Preferably, a fabric is introduced into the coating after it has been or as it is being arranged and before it is cured and/or dried. More preferably, the coating is vulcanized, even more preferably cold-vulcanized, after it has been arranged.

It is possible for the coating to be provided by means of spray coating and/or by means of a corresponding adhesive bonding process and/or by means of a shrink-fitting process.

It is possible for the rubber layer 9, in particular the printing blanket, the covering or the coating, to be of multi-layer configuration and to have at least one fabric layer, or to be provided or applied as such. It is alternatively possible for the rubber layer 9, in particular the printing blanket, the covering or the coating, to be of single-layer configuration, or to be applied as such.

Preferably, the rubber layer 9, preferably a volume unit of the rubber layer 9, in particular of the printing blanket, of the covering or of the coating, comprises the constituents rubber, in particular soft rubber or hard rubber, fabric and gas. It is possible for the rubber layer 9, preferably the volume unit of the rubber layer 9, in particular of the printing blanket, of the covering or of the coating, to have the following composition, wherein the composition is selected so as to make up 100 vol. % in sum total:

### Rubber, in Particular Soft Rubber or Hard Rubber:

30 vol. % to 60 vol. %, more preferably 35 vol. % to 55 vol. %, even more preferably
40 vol. % to 50 vol. %,

### Fabric:

30 vol. % to 60 vol. %, more preferably 35 vol. % to 55 vol. %, even more preferably 40 vol. % to 50 vol. %,

### Gas:

0 vol. % to 25 vol. %, more preferably 1 vol. % to 15 vol. %, even more preferably 5 vol. % to 15 vol. %.

It is possible for the roller outer surface 4 to be formed by a functional layer 6. The roller outer surface 4 preferably has no rubber, in particular soft rubber or hard rubber.

Preferably, the functional layer 6 is in contact with the rubber layer 9, in particular with the printing blanket, the covering or the coating, or is arranged as such. It is possible for the functional layer 6 to be of single-layer or multi-layer configuration or form. The functional layer 6 is preferably arranged on the rubber layer 9 over the full area thereof.

It is possible for the roller outer surface 4, in particular the functional layer 6, to be designed such that the charge generated by friction is dissipated. Preferably, the roller outer surface 4 is conductive or dissipative, or is configured as such.

Preferably, the roller outer surface has a sheet resistance R_{□} selected from a range from 0.001Ω/□ to 5000Ω/□, preferably from 0.01Ω/□ to 500Ω/□, more preferably from 0.1Ω/□ to 1 Ω/α.

In particular, the sheet resistance R_{□} may be measured or determined using the 2-point method (2PP) and/or the 4-point method (4PP) and/or the Hall effect method and/or the van der Pauw method, wherein all of these methods are electrical testing methods which can be used for testing, by contact, the electrical parameter of layer resistance, in particular sheet resistance R_{□} of the functional layer.

By contrast, if it is intended to measure the sheet resistance R_{□} contactlessly, this may be performed using the eddy current method, in which so-called eddy currents are induced in the conductive materials, which then give rise to a secondary field opposed to the primary field, from which it is then possible to determine the layer resistance, in particular the sheet resistance R_{□} of the functional layer.

It is possible for the roller outer surface 4, in particular the functional layer 6, to have conductive or dissipative constituents.

In particular, the functional layer 6 comprises metals, in particular selected from the group consisting of iron, nickel, titanium, chromium, molybdenum, manganese, tantalum, copper, gold, silver, aluminum or mixtures and alloys thereof. In a preferred embodiment, the functional layer 6 has aluminum.

It is possible for the functional layer 6 to have a metal alloy selected from the group consisting of iron-nickel, copper-nickel, nickel-copper, nickel-chromium or mixtures thereof.

Preferably, the roller outer surface 4, in particular the functional layer 6, consists entirely of metal, in particular selected from the above group, or has a binder, in particular a polymer. The binder may be conductive, dissipative or non-conductive.

The roller outer surface 4, in particular the functional layer 6, preferably has conductive or dissipative carbon modifications, in particular selected from the group consisting of graphene, fullerenes, carbon nanotubes, graphite, carbon black or combinations thereof. It is possible for the roller outer surface 4, in particular the functional layer 6, to have conductive or dissipative polymers. It is possible for the roller outer surface 4, in particular the functional layer 6, to have a combination of metal, conductive or dissipative carbon modifications and/or conductive or dissipative polymers.

As an alternative to a conductive or dissipative functional layer, it is possible for the Fermi levels φ of the roller outer surface 4, in particular the functional layer, and of the carrier ply 12 to be aligned with one another. Expediently, the difference between the Fermi levels φ of the roller outer surface, in particular of the functional layer, and of the carrier ply is reduced. A mutual alignment may be achieved for example by selectively choosing the constituents of the roller outer surface, in particular of the functional layer, and of the carrier ply. In particular, the Fermi levels φ of the roller outer surface 4 of the transfer roller 2, in particular the functional layer 6, and of the carrier ply 12 are substantially equal, in particular in a cleaned state and/or in a standard atmosphere. In particular, in this case, the roller outer surface 4, in particular the functional layer 6, is non-conductive, or is configured as such. In particular, it is possible for the constituents of the roller outer surface 4, in particular of the functional layer, and of the carrier ply 12 to be selected such that the work functions of the roller outer surface 4, in particular of the functional layer, and of the carrier ply 12 differ by at most 30%, preferably at most 20%, more preferably at most 15%.

The constituents of the roller outer surface 4 of the transfer roller 2, in particular of the functional layer 6, and the carrier ply 12 are preferably selected such that these lie close together with reference to the triboelectric series. In particular, the spacing, in the triboelectric series, of the roller outer surface 4 of the transfer roller 2 and the carrier ply 12 is less than the spacing of the roller outer surface and of the carrier ply 12 to air or rubber layer.

Preferably, the roller outer surface 4 of the transfer roller 2, in particular the functional layer 6, is formed from the same polymer as the carrier ply 12.

It is possible for the polymer of the roller outer surface 4 of the transfer roller 2, in particular of the functional layer 6, and of the carrier ply 6 to be selected from the group consisting of PFP, polyethylene, polycarbonate, polypropylene, polyvinyl chloride, polystyrene, polyethylene terephthalate, acrylonitrile butadiene styrene copolymer, cellophane, polybutylene terephthalate, polymethyl methacrylate, polylactide, cellulose diacetate, cellulose triacetate, BO-PET, starch blends, or copolymers and/or blends thereof. Preferably, the polymer of the roller outer surface 4, in particular of the functional layer 6, is composed of polyethylene terephthalate, preferably of biaxially oriented polyethylene terephthalate.

In a preferred embodiment, the roller outer surface 4 of the transfer roller 2, in particular the functional layer 6, and the carrier ply 12, in particular the transfer film rear side 121, consist substantially of polyethylene terephthalate, preferably of biaxially oriented polyethylene terephthalate. In a further preferred embodiment, the roller outer surface 4 of the transfer roller 2, in particular the functional layer 6, and the carrier ply 12, in particular the transfer film rear side 121, consist substantially of polycarbonate.

It is possible for the roller outer surface 121, in particular the functional layer 6, to be formed from constituents which have a dielectric strength selected from a range from 5 kV/mm to 800 kV/mm, preferably from 100 kV/mm to 350 kV/mm, more preferably from 150 kV/mm to 300 kV/mm, in particular measured in a standard atmosphere and preferably in the case of cleaned surfaces. In particular, the dielectric strength is determined in accordance with a method described in in DIN EN 60243-2 VDE 0303-22:2014-08.

It is possible for the carrier ply 12 to consist of a constituent selected from the group consisting of PFP, polyethylene, polypropylene, polyvinyl chloride, polycarbonate, polystyrene, polyethylene terephthalate, polybutylene terephthalate, polylactide, cellulose diacetate, cellulose triacetate, BO-PET, starch blends, acrylonitrile butadiene styrene copolymer, cellophane, polymethyl methacrylate or copolymers and/or blends thereof. The carrier ply 12 is preferably composed of polyethylene terephthalate, preferably of biaxially oriented polyethylene terephthalate, and is in particular non-conductive.

It is also possible for the carrier ply 12 to be a co-extruded product, a tri-extruded product or a multi-extruded product from the above group. The carrier ply 12 may also be filled or coated. It is possible for the carrier ply 12 to be a multilayer composite and/or a fabric carrier. A biopolymer-based carrier ply 12 is also possible.

It is possible for the carrier ply 12 to have, or be provided with, a layer thickness in the range from 4 μm to 5000 μm, preferably from 6 μm to 250 μm, more preferably from 9 μm to 23 μm.

It is possible for the carrier ply 12 to have, or be provided with, surface properties selected from the group consisting of smooth, rough, fully or partially structured and/or microstructured, perforated, fully or partially coated, or combinations thereof. It is also possible for the carrier ply 12 to be colored and/or transparent or opaque.

The transfer film 10 or the substrate 7 may be provided in the form of roll material or in the form of sheet material.

The system 1 according to the invention may preferably be arranged in a device, preferably cold stamping device and/or hot stamping device. The process carried out by means of the system 1 and/or the device is preferably a cold stamping process and/or a hot stamping process.

The device and/or the system 1 preferably has at least one or more apparatus(es) for accommodating rolls of film, in particular of the transfer film 10 and/or of the carrier ply 12 and/or of the substrate 7. The device and/or the system 1 preferably has an unwinding apparatus by means of which the provided transfer film 10 can be fed to the process and which, in the advancing direction, is arranged upstream of the roller gap 5—gap between the roller outer surface 4 of the transfer roller 2 and the counterpressure roller 3. The device and/or the system 1 preferably has a winding apparatus by means of which the carrier ply 12 can be discharged from the process and which, in the advancing direction, is arranged downstream of the roller gap 5. The device preferably has a tensioning device 14 for fastening the tensioning aid 13 above the transfer roller.

The device preferably has one or more printing apparatuses, in particular apparatuses for relief printing, planographic printing, screen printing, gravure printing, inkjet printing or combinations thereof, which, in the advancing direction, is arranged upstream of the system 1, in particular upstream of the roller gap 5—gap between the roller outer surface 4 of the transfer roller 2 and the counterpressure roller 3. Preferably, in particular by means of at least one of the printing apparatuses, an adhesive layer 8, in particular a cold stamping adhesive layer or a hot stamping adhesive layer, is applied to the substrate 7. The adhesive layer 8 is preferably a UV-curable adhesive layer. It may be advantageous if the device has a curing apparatus, in particular comprising a UV source, for curing the adhesive layer 8. This is advantageous if the device and/or the system 1 is arranged in a cold stamping process or is a cold stamping apparatus.

It is possible for the transfer roller 2 and/or the counterpressure roller 3 to be heatable, in particular if a hot stamping adhesive layer is present or arranged on the substrate 7 or the transfer ply 11. The adhesive layer 8 is preferably a hot-melt adhesive layer. This is advantageous if the device and/or the system 1 is arranged in a hot stamping process or is a hot stamping apparatus.

In particular, the system 1 and/or the device has at least one control apparatus for controlling the feed of the transfer film 10 and/or of the substrate 7 to the roller gap 5—gap between the roller outer surface 4 of the transfer roller 2 and the counterpressure roller 3. In particular, the feed of the transfer film 10 in the roller gap 5 is stopped by virtue of the unwinding apparatus and/or winding apparatus for the transfer film 10 being stopped, by virtue of the film tension of the transfer film 10 being adjusted, and/or by virtue of a dancer roller that is in contact with the transfer film 10 being moved.

It is possible for the absolute value of the maximum rotational speed of the transfer roller 2 at a point arranged on the roller outer surface to lie in the range from 500 revolutions/h to 30000 revolutions/h, preferably from 5000 revolutions/h to 24000 revolutions/h, more preferably from 15000 revolutions/h to 18000 revolutions/h, in particular in relation to the central point of the roller.

FIG. 2 shows a simplified system 1 such as is currently used in the prior art, in which the transfer roller 2 is brought into contact with the transfer film 10. The various positions A to D are marked for the purposes of illustrating the process of the formation of a potential difference between the carrier ply 12 and the roller outer surface 4. Position A shows the roller outer surface 4 and the carrier ply 12 before they make direct contact in the roller gap 5—gap between the roller outer surface 4 of the transfer roller 2 and the counterpressure roller 3. In position B, the roller outer surface 4 is in contact with the transfer film rear side 121 of the carrier ply 12 in the rotor gap 5, and the two surfaces are rubbed against one another. Position C shows the separation of the roller outer surface 4 of the transfer roller 2 and the carrier ply 12 downstream of the roller gap 5. Position D shows a carrier ply 12 and a roller outer surface 4 of the transfer roller 2 after the surfaces thereof have been separated.

FIGS. 3a and 3b schematically show an example which does not conform to the invention, in which the Fermi level φ of the transfer film rear side 121 of the carrier ply 12 is lower than the Fermi level φ of the roller outer surface 4 of the transfer roller 2. It can also be seen that the Fermi energies Er of the transfer film rear side 121 of the carrier ply 12 roller outer surface 4 of the transfer roller 2 are different. Here, the carrier ply 12 and the roller outer surface are non-conductive.

In position A according to FIG. 2, the two surfaces come into contact in an uncharged state, or have a balanced number of positive and negative charges. FIG. 3b shows that, in position A, that is to say directly before the surfaces come into contact, all states up to the Fermi level φ are occupied, and all states of higher energy are unoccupied.

In position B, the carrier ply 12 and a roller outer surface 4 of the transfer roller 2 rub against one another. Owing to the friction in the roller gap 5—gap between the roller outer surface 4 of the transfer roller 2 and the counterpressure roller 3—and the different Fermi levels φ or Fermi energies Er, a charge exchange occurs.

In the example described in FIGS. 3a and 3b, the Fermi level φ of the transfer film rear side 121 is relatively low, with the result that the transfer film rear side 121 of the carrier ply 12 constitutes the electron donor. The Fermi levels φ of the two surfaces are aligned with one another as a result of the friction-induced charge exchange, such that both surfaces have the same Fermi level φ′ or Fermi energy E_{F}′. As a result, the friction in the roller gap 5 in position B causes the transfer film rear side 121 to be positively charged and causes the roller outer surface 4 of the transfer roller 2 to be negatively charged. Following the separation of the surfaces downstream of the roller gap 5, at position C, there is a potential difference (denoted by ΔU) between the transfer film rear side 121 and the roller outer surface 4. Following a sufficient potential difference, a discharge can occur, giving rise to the fault situation in the application process as described further above.

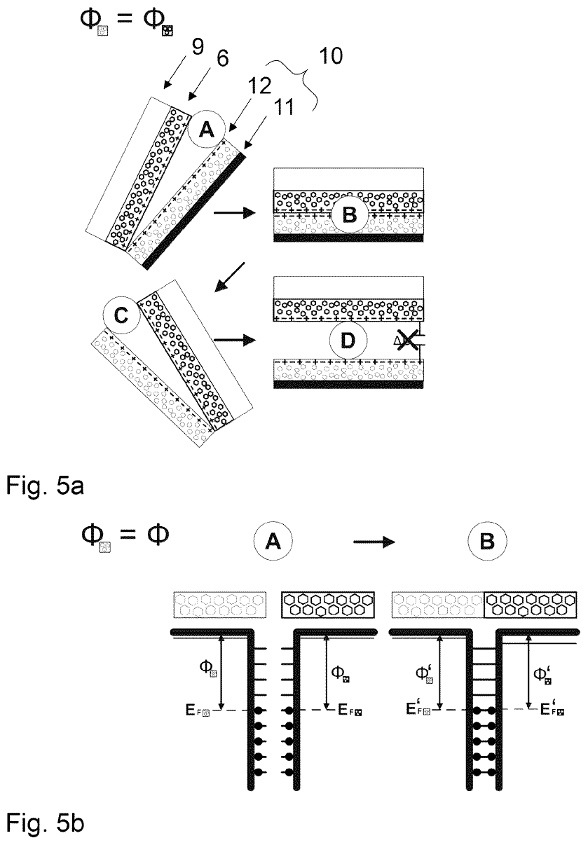

FIGS. 4a and 4b schematically show a further example which does not conform to the invention, in which the Fermi level φ of the transfer film rear side 121 of the carrier ply 12 is higher than the Fermi level φ of the roller outer surface 4 of the transfer roller 2. It is also the case that the Fermi energies Er of the transfer film rear side 121 of the carrier ply 12 roller outer surface 4 of the transfer roller 2 are different. Here, the carrier ply 12 and the roller outer surface 4 of the transfer roller 2 are non-conductive.

Since, in this example, the Fermi level φ of the roller outer surface 4 of the transfer roller 2 is lower than the Fermi level φ of the transfer film rear side 121, the roller outer surface 4 constitutes the electron donor. The progression through the positions A to D causes the transfer film rear side 121 to be negatively charged and causes the roller outer surface 4 of the transfer roller 2 to be positively charged; it is also the case here that, following a sufficient potential difference, a discharge can occur, giving rise to the fault situation in the application process as described further above.

FIGS. 5a and 5b schematically show an embodiment of an example according to the invention in which the Fermi levels φ of the transfer film rear side 121 of the carrier ply 12 and of the roller outer surface 4 of the transfer roller 2 have been aligned, in particular are equal. It is also the case that the Fermi energies Er of the transfer film rear side 121 of the carrier ply 12 roller outer surface 4 of the transfer roller 2 are equal. The progression through the positions A to D according to FIG. 2 does not give rise to a significant difference in charge between the transfer film rear side 121 and the roller outer surface 4 of the transfer roller 2. It is thus also the case that no significant potential difference is generated, such that a discharge, and a fault situation in the application process as described further above, can be avoided.

FIGS. 6a to 6f show exemplary embodiments of roller outer surfaces 4 such as may be used or present in the system 1 or application process according to the invention. FIGS. 6a to 6f each show a functional layer 6 which is arranged on a rubber layer 9. As a specific exemplary embodiment, a printing blanket is provided here as a rubber layer 9 and, at two opposite ends, has tensioning aids 13 in particular in the form of metal strips, by which the tensioning aids can be arranged, in particular with the aid of the tensioning device 14, on the transfer roller 2. In particular, use may be made of the printing blanket of an offset printing process or of an offset printing device.

FIG. 6a shows a functional layer 6 that has been deposited onto the rubber layer 9 from the vapor phase, in particular with a layer thickness in the range from 5 nm to 500 nm, preferably from 10 nm to 200 nm, more preferably from 30 nm to 55 nm. In particular, conductive polymers or the aforementioned metals or metal alloys are deposited. In particular, a conductive or dissipative roller outer surface 4 of the transfer roller 2, in particular functional layer 6, is obtained.

FIG. 6b shows a functional layer 6 that has been deposited onto the rubber layer 9 from a salt solution, in particular with a layer thickness in the range from 5 nm to 600 nm, preferably from 20 nm to 300 nm, more preferably from 70 nm to 150 nm. In particular, a conductive or dissipative roller outer surface 4, in particular functional layer 6, composed of the aforementioned metals, in particular silver, is obtained here. For the deposition of the functional layer 6, an aqueous salt solution is preferably provided, to which a reducing agent is added. The salt solution preferably comprises salts selected from the group consisting of AgNO₃, NiSO₄, CuSO₄, K[Au(CN)₂], Na₃[Au(SO₃)₂], SnCl₂ or combinations thereof.

Examples for metallization electrolytes (Source: “Verfahren der Oberflächentechnik” [“Surface engineering methods”], 1st edition 2004, ISBN 9783446222281) include the following:

### Ag Deposition:

0.6 g silver nitrate
   50 ml distilled H₂O
   0.8 g NaOH and 50 ml distilled H₂O and a few drops of 25% NH₄OH

### Ni Deposition:

NISO₄·7H₂O 20 g/l to 30 g/l
   NaH₂PO₂·H₂O 10 g/l to 20 g/l
   Acetic acid 10 g/l with NaOH to pH 4.5
   Thiourea 0.7 mg/l
NiSO₄·7H₂O 20 g/l
   NaH₂PO₂·H₂O 15 g/l
   Lactic acid 30 g/l
   Propionic acid 3 g/l
   Pb(NO₃)₂ 1 mg/l with Na-acetate to pH 4 to 5
NiSO₄·7H₂O 20 g/l
   NaH₂PO₂·H₂O 15 g/l
   Citric acid 15 g/l
   Na₂B₄O₇·10 H₂O 15 g/l with NaOH to pH 9.5

### Cu Deposition:

CuSO₄·5H₂O 10 g/l
   Methanal (formalin solution 30%) 20 ml/l
   EDTA 16 g/l
   NaOH 10 g/l
CuSO₄·5H₂O 5 to 10 g/l
   Methanal (formalin solution 30%) 35 ml/l
   Potassium sodium tartrate KNaC₄H₄O₄·4H₂O 5 to 10 g/l
   Thiourea 0.05 mg/l
   NaOH 4 g/l to 5 g/l

### Au Deposition:

K[Au(CN)₂] 5 g/l to 15 g/l
   KBH₄ 12 g/l to 17 g/l
   KCN 10 g/l to 15 g/l
   KOH 10 g/l to 13 g/l
K[Au(CN)₂] 5 g/l
   COCl₂·6H₂O 20 g/l
   NiCl₂·6H₂O 10 g/l
   Thiourea 25 g/l
   Di-ammonium hydrogen citrate 20 g/l
Na₃[Au(SO₃)₂] 0.6 g/l
   Methanal (formalin solution 30%) 20 ml/l 0.3 g/l to 0.5 g/l
   Na₂SO₃ 5 g/l
   Ethylenediamine (50%) 0.85 g/l
   Sodium citrate dihydrate 8 g/l
   NH₄Cl 15 g/l

### Sn Deposition:

SnCl₂·2H₂O 7.5 g/l
   Na₂HPO₂·7H₂O 2 g/l
   EDTA 15 g/l
   Sodium acetate 10 g/l
   Benzenesulfonic acid 1 ml/l
SnCl₂·2 H₂O 5 g/l
   Thiourea 50 g/l
   H₂SO₄ 20 g/l

It is possible for the functional layer to be obtained using at least one of the above salt mixtures.

FIG. 6c and FIG. 6d show a rubber layer 9 on which a functional layer 6 has been arranged, or is present, as a lacquer layer. Preferably, the lacquer layer is applied with a layer thickness selected from the range from 2 μm to 100 μm, preferably from 10 μm to 25 μm. The functional layer 6 is preferably applied as a print lacquer, spray lacquer, reaction lacquer or as a combination thereof. It is possible for the functional layer 6, in particular lacquer layer, to be printed on, in particular by means of a printing process and/or spraying process selected from the group consisting of relief printing, planographic printing, screen printing, gravure printing, inkjet printing or combinations thereof.

The functional layer 6 shown in FIG. 6c is in particular a conductive or dissipative lacquer layer, and is produced in particular from a conductive lacquer. The conductive lacquer is in particular a silver conductive lacquer or conductive silver, a copper conductive lacquer, and/or a graphite conductive lacquer. In particular, the conductive lacquer or the conductive or dissipative lacquer layer comprises one or more of the following particles, in particular nanoparticles: silver, copper, conductive carbon modifications, in particular graphene, carbon nanotubes, carbon black or graphite, gold, aluminum and/or metal alloys. In particular, a conductive or dissipative roller outer surface 4 of the transfer roller 2, in particular functional layer 6, is obtained. The conductive lacquer preferably comprises a lacquer, a polymer dispersion, a polymer solution, or a synthetic resin, as a binder. The lacquer layer, in particular conductive or dissipative lacquer layer, preferably comprises a polymer as a binder.

As an alternative to the conductive lacquer, in order to preferably targetedly dissipate charges owing to the indexing, it is possible for a non-conductive lacquer layer to be provided. This embodiment is shown in FIG. 6d. The non-conductive lacquer layer preferably comprises a polymer dispersion, a polymer solution, or a synthetic resin, as a binder. The non-conductive lacquer layer preferably comprises a non-conductive polymer as a binder. In other words, the lacquer layer does not have any conductive or dissipative constituents. The non-conductive lacquer layer or the binder thereof is preferably formed from the same polymer as the carrier ply 12 of the system 1 according to FIG. 1.

It is possible for the polymer of the non-conductive lacquer layer and of the carrier ply 12 to be selected from the group consisting of PFP, polyethylene, polypropylene, polycarbonate, polyvinyl chloride, polystyrene, polyethylene terephthalate, acrylonitrile butadiene styrene copolymer, cellophane, polybutylene terephthalate, polylactide, cellulose diacetate, cellulose triacetate, BO-PET, starch blends, polymethyl methacrylate, or copolymers and/or blends thereof. The polymer of the non-conductive lacquer layer and of the carrier ply is preferably polyethylene terephthalate.

The lacquer layer according to FIGS. 6c and 6d, in particular the conductive or dissipative lacquer layer or the non-conductive lacquer layer, preferably comprises a solvent-based or water-based binder. The binder may be of single-component or two-component or multi-component form.

The lacquer layer, in particular the conductive or dissipative lacquer layer or the non-conductive lacquer layer, is preferably of single-layer or multi-layer configuration. It is possible for the functional layer 6, preferably the lacquer layer, more preferably the conductive or dissipative lacquer layer or the non-conductive lacquer layer, to comprise a plurality of layers which are of different composition. It is also possible for the lacquer layer, in particular the conductive or dissipative lacquer layer or the non-conductive lacquer layer, to be formed in a layer composite. For example, the lacquer layer, in particular the conductive or dissipative lacquer layer, may be present in conjunction with one or a plurality of vapor-deposited metal layers or transparent oxide layers.

FIGS. 6e, 6f and 6g show functional layers 6, provided as films, arranged on rubber layers 9. The film is preferably laminated or stamped onto the rubber layer 9.

Preferably, the film is a metal film, or is provided as such. The film, in particular the metal film, preferably has a layer thickness in the range from 2 μm to 200 μm, preferably from 5 μm to 100 μm, more preferably from 20 μm to 40 μm, wherein the layer thicknesses are layer thicknesses of the pure metal film. A corresponding adhesive layer, in particular for arranging the metal film on the roller outer surface 4, preferably has a layer thickness in the range from 5 μm to 250 μm, preferably from 10 μm to 100 μm, more preferably from 20 μm to 50 μm.

Preferably, the film is a polymer film, or is provided as such. This film, in particular the polymer film, preferably has a layer thickness in the range from 4 μm to 500 μm, preferably from 6 μm to 50 μm, more preferably from 6 μm to 12 μm, wherein the layer thicknesses are layer thicknesses of the pure polymer film without additionally applied layers. A corresponding adhesive layer, in particular for arranging the polymer film on the roller outer surface 4, preferably has a layer thickness in the range from 5 μm to 250 μm, preferably from 10 μm to 100 μm, more preferably from 20 μm to 50 μm.

In the embodiment of FIG. 6e, the film is provided as a polymer film. A non-conductive roller outer surface 4 is thus obtained. Preferably, the polymer film is formed from the same polymer as the carrier ply 12, wherein the polymer is preferably selected from the group consisting of PFP, polyethylene, polypropylene, polyvinyl chloride, polystyrene, polyethylene terephthalate, acrylonitrile butadiene styrene copolymer, cellophane, polycarbonate, polybutylene terephthalate, polylactide, cellulose diacetate, cellulose triacetate, BO-PET, starch blends, polymethyl methacrylate, or copolymers and/or blends thereof. The polymer film is preferably composed of polyethylene terephthalate, in particular of biaxially oriented polyethylene terephthalate.

In the embodiment of FIG. 6e, the film is provided as a metal film. A conductive or dissipative roller outer surface 4 of the transfer roller 2, in particular composed of the above-described metals or metal alloys, is thus obtained.

In the embodiment of FIG. 6f, a polymer film is provided which has a metal layer. As a film, it is also possible for a polymer film to be provided which has a metal layer, wherein the metal layer is arranged on that side of the film which faces away from the roller. The metal layer, in particular composed of the metals or metal alloys described above, thus forms the roller outer surface 4 of the transfer roller 2, with a conductive or dissipative roller outer surface 4 being obtained. Preferably, the polymer film has a layer thickness in the range from 4 μm to 500 μm, preferably from 6 μm to 50 μm, more preferably from 6 μm to 12 μm.

It is possible for the metal layer to be deposited from the vapor phase, in particular with a layer thickness in the range from 5 nm to 500 nm, preferably from 10 nm to 200 nm, more preferably from 30 nm to 55 nm. In particular, in this case, metals or metal alloys are deposited which are in particular selected from the group consisting of iron, nickel, titanium, chromium, molybdenum, manganese, tantalum, copper, gold, silver, aluminum or mixtures and alloys thereof.

It is possible for an adhesive layer 8 to be arranged between the film and the rubber layer 9, in particular the printing blanket, the covering or the coating. It is alternatively or additionally possible for the film, in particular the polymer film or the metal film, to be provided with an adhesive layer 8, wherein the adhesive layer 8 is arranged on that side of the film which faces toward the roller. Preferably, the adhesive layer 8 is arranged with, or has, a layer thickness in the range from 5 μm to 250 μm, preferably from 10 μm to 100 μm, more preferably from 20 μm to 50 μm.

As an alternative to the lamination or stamping of the film onto the rubber layer 9, in particular by using an adhesive layer 8, it is possible for the film, in particular polymer film and/or metal film, to be clamped onto the printing blanket by means of tensioning aids 13, in particular in the form of two metal strips. For this purpose, the printing blanket and the film, in particular polymer film and/or metal film, are interconnected by means of two tensioning aids 13, preferably by means of two metal strips, wherein, in particular, the printing blanket is then fastened or stretched onto the transfer roller 2 by means of the two tensioning aids 13 and by means of a tensioning device situated on the transfer roller 2. A printing blanket comprising the film is thus obtained.

These exemplary embodiments according to FIGS. 6a to 6f are not to be understood as limiting. The rubber layer 9 may alternatively also be provided as a covering or a coating, in particular arranged on a transfer roller 2. It is also alternatively possible for the functional layer 6 to be provided as a hose, sleeve or covering, wherein, in particular, these may be configured in the manner of the films described in FIGS. 6e to 6f. In other words, the film may be configured as a hose, sleeve or covering. Preferably, the film has a layer thickness in the range from 4 μm to 500 μm, preferably from 6 μm to 50 μm, more preferably from 6 μm to 12 μm, and is preferably a polymer film.

The design variants presented may self-evidently be combined with one another as desired, and do not constitute any limitation.

### LIST OF REFERENCE SIGNS

1 System
2 Transfer roller
3 Counterpressure roller
4 Roller outer surface
5 Roller gap (gap between the transfer roller 2 and the counterpressure
roller 3)
6 Functional layer
7 Substrate
8 Adhesive layer
9 Rubber layer
10 Transfer film
11 Transfer ply
12 Carrier ply
121 Transfer film rear side
13 Tensioning aid
14 Tensioning device

1. A system for an indexed process of applying a transfer ply to a substrate, the system comprising a transfer roller and a counterpressure roller, and a transfer film,
wherein the transfer roller has a roller outer surface, and the transfer roller and the counterpressure roller form a roller gap,
wherein the transfer film has a carrier ply and has a transfer ply that is detachable from the carrier ply, and the transfer film rear side is formed by the carrier ply and the transfer film front side is formed by the transfer ply,
wherein the transfer film rear side is in contact with the roller outer surface of the transfer roller and the transfer film front side is in contact with the substrate in the roller gap, wherein the transfer ply is applied to at least parts of the substrate,
wherein the system is designed so as to avoid the generation of a potential difference greater than the breakdown voltage of the transfer film, of the roller outer surface of the transfer roller and/or of the surrounding gas phase as a result of the friction between the roller outer surface of the transfer roller and transfer film rear side during the application process, and
wherein the roller outer surface of the transfer roller has:
a sheet resistance R_{□} in the range from 0.001Ω/□ to 5000Ω/□, and/or
a Fermi level aligned with a Fermi level of the transfer film rear side.

2. The system according to claim 1, wherein the roller outer surface of the transfer roller is conductive or dissipative.

3. The system according to claim 1, wherein Fermi levels of the roller outer surface of the transfer roller and of the transfer film rear side are aligned with one another.

4. The system according to claim 1, wherein
the roller outer surface of the transfer roller is formed by a functional layer.

5. The system according to claim 1, wherein the roller outer surface of the transfer roller is formed from the same polymer as the carrier ply.

6. The system according to claim 1, wherein the polymer of the roller outer surface of the transfer roller and of the carrier ply is selected from the group consisting of PFP, polyethylene, polypropylene, polyvinyl chloride, polystyrene, polyethylene terephthalate, polycarbonate, polybutylene terephthalate, polylactide, cellulose diacetate, cellulose triacetate, BO-PET, starch blends, acrylonitrile butadiene styrene copolymer, cellophane, polymethyl methacrylate or copolymers and/or blends thereof.

7. The system according to claim 1, wherein the roller outer surface of the transfer roller is formed from constituents which have a dielectric strength selected from a range from 5 kV/mm to 800 kV/mm.

8. (canceled)

9. The system according to claim 1, wherein the roller outer surface of the transfer roller has a sheet resistance R_{□} in the range from 0.01Ω/□ to 500 Ω/□.

10. The system according to claim 1, wherein the roller outer surface of the transfer roller has conductive constituents.

11. The system according to claim 1, wherein the roller outer surface of the transfer roller consists entirely of metal or has a binder.

12. (canceled)

13. The system according to claim 1, wherein the roller outer surface of the transfer roller has no rubber.

14. The system according to claim 1, wherein the transfer roller has a rubber layer comprising rubber.

15. The system according to claim 14, wherein the rubber layer is of multi-layer configuration and has at least one fabric layer.

16. The system according to claim 15, wherein the rubber layer comprises the constituents rubber fabric and gas.

17. The system according to claim 15, wherein the rubber layer has a tensioning aid.

18. (canceled)

19. The system according to claim 1, wherein the carrier ply consists of a constituent selected from the group consisting of PFP, polyethylene, polypropylene, polyvinyl chloride, polycarbonate, polybutylene terephthalate, polylactide, cellulose diacetate, cellulose triacetate, BO-PET, starch blends, polystyrene, polyethylene terephthalate, acrylonitrile butadiene styrene copolymer, cellophane, polymethyl methacrylate or copolymers and/or blends thereof.

20-21. (canceled)

22. A method for producing the transfer roller having a roller outer surface according to claim 1, wherein the method has the following steps:
a) providing a transfer roller,
b) arranging a rubber layer on the transfer roller,
c) arranging a functional layer on the rubber layer,
d) obtaining a transfer roller in the case of which the functional layer forms the roller outer surface of the transfer roller.

23. The method according to claim 22, wherein the rubber layer is provided by a printing blanket or a covering or by at least one coating which is obtained from at least one coating composition.

24. The method according to claim 22, wherein the rubber layer is provided or applied in a multi-layer configuration and has at least one fabric layer.

25. The method according to claim 22, wherein the rubber layer comprises rubber.

26. (canceled)

27. The method according to claim 22, wherein the functional layer is deposited from the vapor phase.

28. The method according to claim 22, wherein the functional layer is deposited from a salt solution.

29. The method according to claim 28, wherein the salt solution comprises salts selected from the group consisting of AgNO₃, NiSO₄, CuSO₄, K[Au(CN)₂], Na₃[Au(SO₃)₂], SnCl₂ or of combinations thereof.

30. The method according to claim 22, wherein the functional layer is applied as a lacquer layer or as a polymer dispersion.

31. The method according to claim 30, wherein the lacquer layer is applied with a layer thickness in the range from 2 μm to 100 μm.

32. The method according to claim 30, wherein the functional layer is printed on.

33. The method according to claim 22, wherein the functional layer is of single-layer or multi-layer form.

34. The method according to claim 22, wherein the functional layer is provided as a film.

35-36. (canceled)

37. The method according to claim 34, wherein the functional layer is laminated or stamped onto the rubber layer.

38. The method according to claim 34, wherein the functional layer is clamped onto the rubber layer by means of a tensioning aid.

39. The method according to claim 34, wherein the functional layer is provided as a hose, sleeve or covering.

40. The method according to claim 34, wherein an adhesive layer is arranged between the film and the rubber layer or the film is provided with an adhesive layer facing toward the transfer roller.

41. (canceled)

42. The method according to claim 22, wherein the functional layer is of conductive, dissipative or non-conductive form.

43. The method according to claim 22, wherein the roller outer surface comprises metals selected from the group consisting of iron, nickel, titanium, chromium, molybdenum, manganese, tantalum, copper, gold, silver, aluminum or mixtures and alloys thereof, and/or conductive carbon modifications.

44. A process for the indexed application of a transfer ply to a substrate by means of a system according to claim 1, wherein the transfer film is fed along the transfer roller into the roller gap, wherein the carrier ply forms the transfer film rear side and is in contact with the roller outer surface transfer roller,
and wherein the transfer ply is brought into contact with the substrate in the roller gap, wherein the transfer ply is at least partially transferred to the substrate, and
wherein, during the process, the occurrence of a potential difference greater than the breakdown voltage of the transfer film, of the roller outer surface transfer roller and/or of the surrounding gas phase as a result of the friction between the roller outer surface transfer roller and the transfer film rear side is avoided.

45. The process according to claim 44, wherein the process is a cold stamping process or a hot stamping process.

46-47. (canceled)

48. The process according to claim 44, wherein the feed of the transfer film in the roller gap is locally stopped by adjustment of the film tension of the transfer film and/or by virtue of an unwinding apparatus for the transfer film being stopped.
